(19) United States
(12) Patent Application Publication
(10) Pub. No.: US 2022/0289061 A1
(43) Pub. Date: Sep. 15, 2022

(54) SYSTEM AND PROCESS FOR CHARGING A VEHICLE

(71) Applicant: Avinash Vijai SINGH, Manorhaven, NY (US)

(72) Inventor: Avinash Vijai SINGH, Manorhaven, NY (US)

(21) Appl. No.: 17/690,619

(22) Filed: Mar. 9, 2022

Related U.S. Application Data
(60) Provisional application No. 63/159,218, filed on Mar. 10, 2021.

(51) Int. Cl. B60L 53/65; G07C 5/10; B60L 1/00

(52) U.S. Cl. CPC B60L 53/65; G07C 5/10; B60L 1/00

(57) ABSTRACT

A system and process for charging an automobile comprising the following steps logging in as a user to a system requesting a vehicle, requesting a start time, requesting a route, determining using the system comprising a microprocessor, an estimated amount of power needed, determining a base amount of power, determining an additional amount of power, charging the vehicle, presenting the vehicle for use.

### CROSS REFERENCE TO RELATED APPLICATIONS

This application is a non-provisional application that hereby claims priority to U.S. Patent Application Ser. No. 61/159,218 filed on Mar. 10, 2021 the disclosure of which is hereby incorporated herein by reference.

### BACKGROUND OF THE INVENTION

At least one embodiment relates to a system and a process for charging a vehicle. Vehicles that rely on battery power can have availability issues wherein the vehicle battery may not be charged in time for use by another party. Therefore, there is a need to calculate charging time and availability of the vehicle battery via a computer network.

### SUMMARY OF THE INVENTION

A system and process for charging an automobile comprising the following steps logging in as a user to a system requesting a vehicle, requesting a start time, requesting a route, determining using the system comprising a microprocessor, an estimated amount of power needed, determining a base amount of power, determining an additional amount of power, charging the vehicle, presenting the vehicle for use.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1A is a flow charge of the process for charging a vehicle;

FIG. 1B is a flow chart for enrolling drivers and autos in the charging and reservation system;

FIG. 1C is a schematic block diagram of a map for autos, charging stations and users;

FIG. 1D is a first layout of a network for use with a ride share or ride service;

FIG. 1E is a second layout of a network for use with a ride share or ride service;

FIG. 2 is a flow chart of the variables to consider in charging a vehicle;

FIG. 3 is a flow chart for determining the battery availability in charging the vehicle; and

FIG. 4 is a block diagram of the network for charging the vehicle;

FIG. 5 is a block diagram of a server;

FIG. 6 is a block diagram of an electronic device;

FIG. 7 is a block diagram of an auto.

### DETAILED DESCRIPTION OF PREFERRED EMBODIMENTS

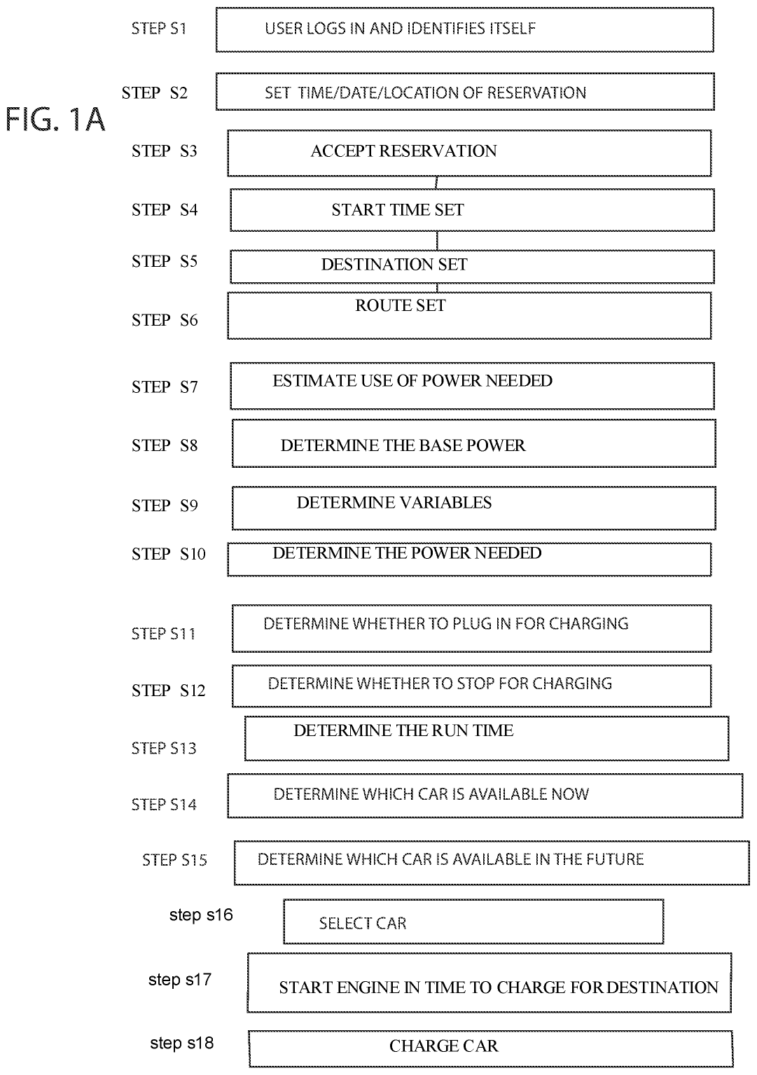

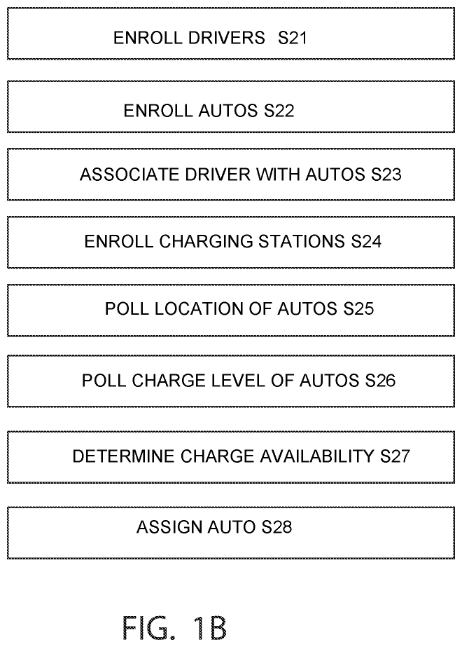

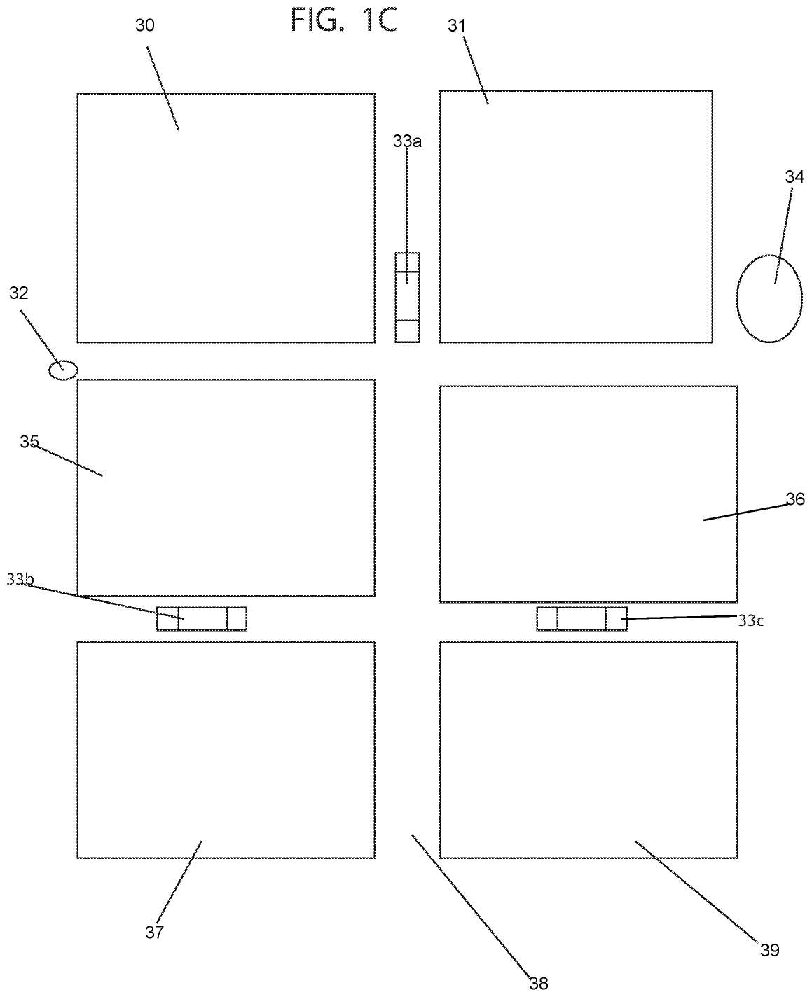

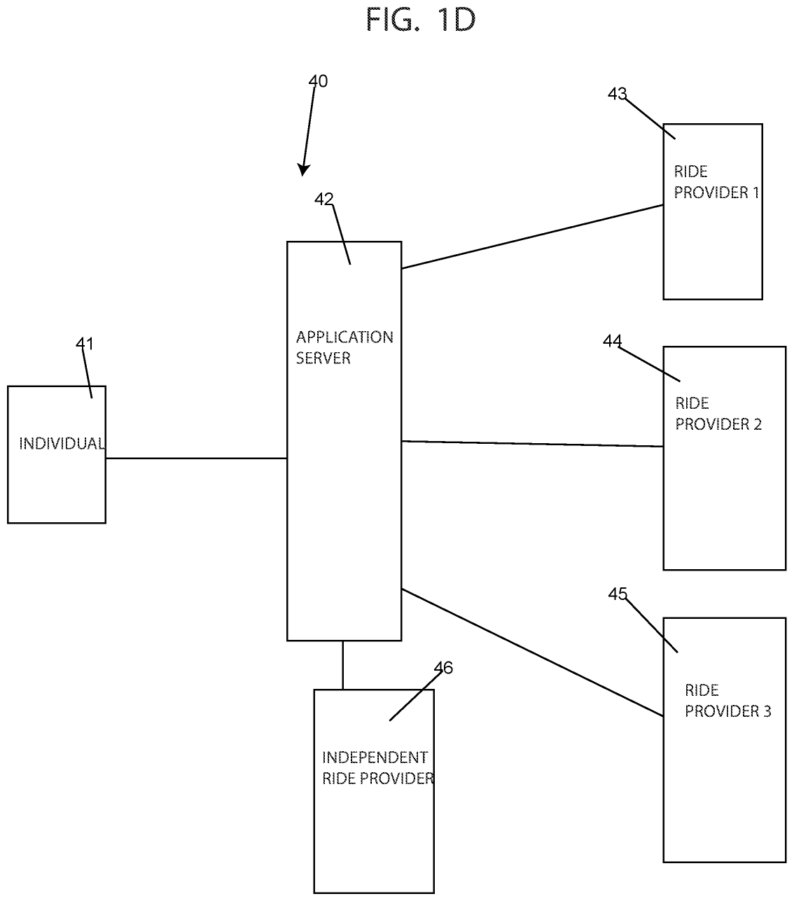

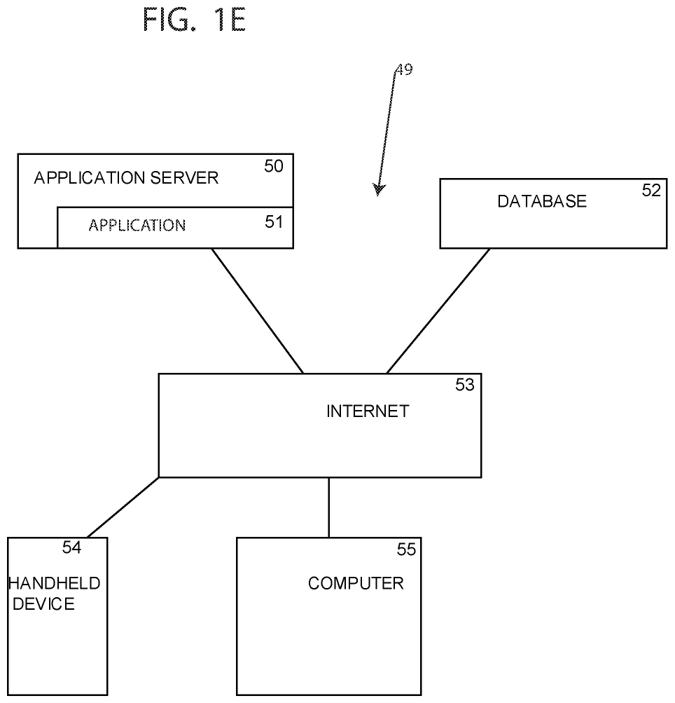

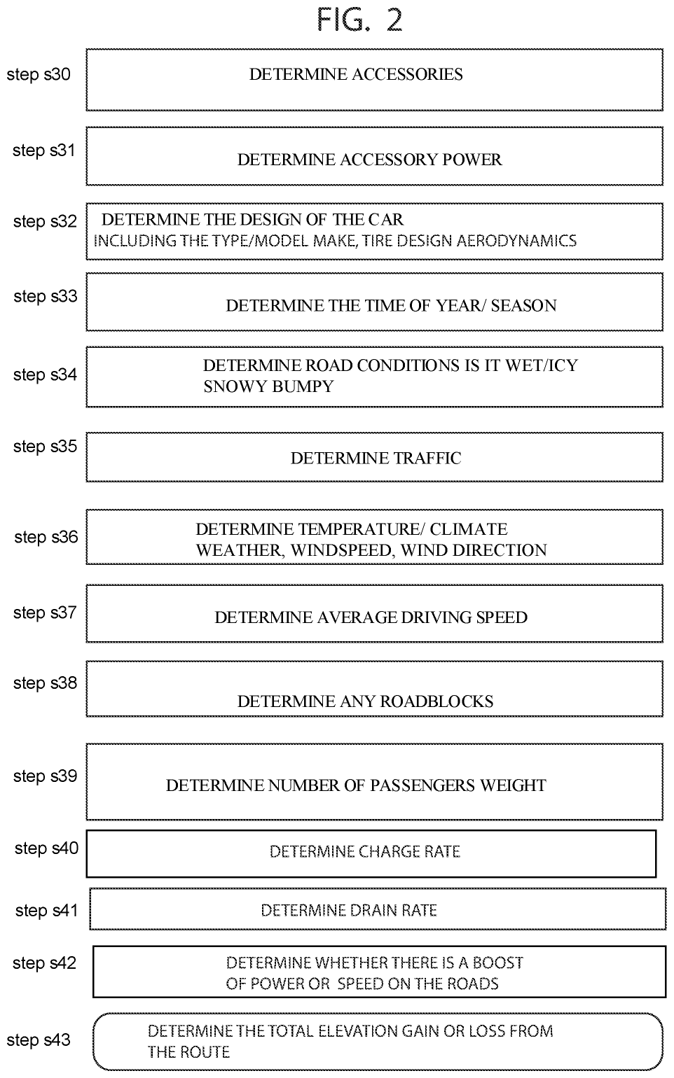

FIG. 1 is a flow charge of the process for charging a vehicle in this embodiment, in step S1 the user logs in and identifies himself. Next, in step S2, the user sets a time, date and location of the reservation. In this case the user can reserve his own car, a ride service such as a taxi service or Uber service or a car sharing system. Next, in step S3 the system can accept the reservation by determining the availability of the vehicle and the availability of a vehicle with a sufficient charge. Next, in step S4, the system can set the time for making the vehicle available. Next, in step S5 the system can set the destination for the reservation of the vehicle. Next in step S6 the system can set the route for the vehicle that the vehicle will travel. Next, in step S7 the system will determine the amount of power that is needed to charge the vehicle or to accomplish the route. Next, in step S8 the system determines the amount of power that is available in the vehicle before the trip. This can be done through wireless or wired communication between the vehicle and a central server of the system. Next, in step S9 the system can determine the variables that may be included in determining the amount of power needed. These variables are listed in FIG. 2. Next, in step S10 the system can determine the amount of power needed to charge the vehicle so that the vehicle has sufficient power to make the route. Next, in step S11 the system can determine whether to plug the vehicle in for charging in advance of use. Next, in step S12 the system can determine whether the vehicle would have to stop along the route for additional charging. Next, in step S13 the system can determine the run time of the vehicle in the route. Next, in step S14 if necessary and if the vehicle is a hybrid self charging vehicle the system can determine whether to start the engine to reach the destination. Next in step S15, the system can charge the car in anticipation of use. In step S16, the user selects a car, auto or motor vehicle. Next, in step S17 the system can either start the engine, start the charging in time for use for arriving at the destination. Next, in step s18 the system can charge the car in advance of the use.

FIG. 1B is a flow chart for enrolling drivers and autos in the charging and reservation system. For example, in this embodiment the system can allow the enrollment of drivers in step S21. Each of the drivers can be enrolled using basic driver information such as name, address, telephone number, SS (social security number), email address, and any other identifying number such as drivers' license number. Next, the system can be used to enroll autos in step S22. The enrollment of drivers and autos can be through the submission of data through a web page or through a portable electronic device such as a phone. With the enrollment of drivers 21 or the enrollment of autos, the use of a phone such as a smartphone allows for photographs of both the driver and the auto. Therefore, the enrollment of the driver and the auto can include photos as well as identifying information. With the enrollment of autos, this includes the information about the auto such as color, make, model, year, registration number, plate number, VIN number, miles driven. The enrollment of either the driver or the auto can also be with an outside driving service or service company as well. The driving service can be in the form of a taxi service or a well known ride sharing service such as UBER®, LYFT® or any other known service. Next, in step S23, the system can associate the drivers with the autos. Thus each driver can be associated with one or more registered autos and vice versa, each auto can be associated with multiple drivers or multiple companies as well. Since the enrollment of drivers and/or autos can be through information such as address, the enrollment through a phone having GPS can involve automatically geolocating the user to a particular region during enrollment based upon the GPS coordinates recorded by the phone during enrollment. Next, in step S24 the system can enroll charging stations in step S24. The enrollment of charging stations in step S24 involves registering these charging stations based upon the location, the type of charge (AC, DC or other type of charging method). This also includes the type of charging adapter, the speed or transfer of the charge, and the number of charging outlets. Next, in step S25 the system can then poll the location of the autos during any given time such as during the day, night or any other time. Next, in step S26, the system can poll the charge level of the autos as well. The charge level would then be determined by the system whether the auto needed to be recharged during step S27. Next, the system, when it receives a request for an auto in FIG. 1A, it determines the charge availability in step S27. This step includes determining the distance between the available auto and the user requesting the auto as well as the level of charge in the auto (see step S26), the distance between the auto and the charging station, the distance between the charging station and the user, the number of available chargers at the charging station, the amount of charge needed, and the time period it would take to charge until the auto would be available. Next in step S28 the system can assign an auto to a route (See steps S14-S16 in FIG. 1A).

FIG. 1C is a schematic block diagram of a map for autos, charging stations and users. In this view there are a series of blocks 30, 31, 35 and 36 which have roads passing through such as road 38. A plurality of cars, 33a, 33b, 33c are positioned on these roads and are available for polling. A user 32 is shown who would request a ride or an automobile from a ride share company. The system would then determine the location of the automobile, the charge of the automobile, determine the nearest charging station such as charging station 34, and the location of the user such as user 32. Then the system would determine which auto such as auto 33a, 33b, 33c is suitable for the task. This would depend on when the user needed the car, the charge level of the available car, the location of the charging station, the time for a charge necessary for the task as shown above in FIGS. 1A and 1B.

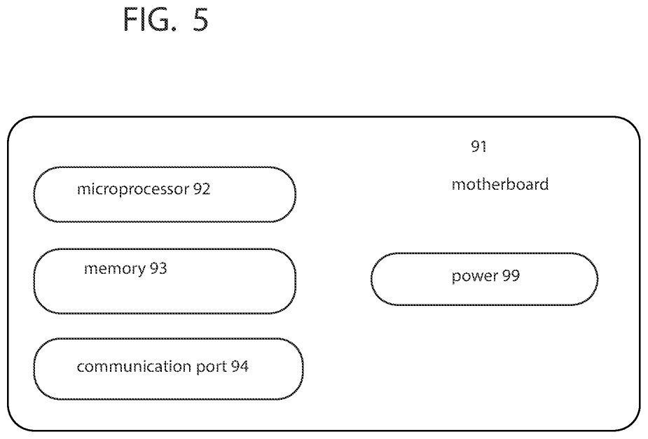

FIG. 1D is a first layout of a network for use with a ride share or ride service. With this network, there is an individual 41 who communicates with the network using either a smartphone or other remote computer. This individual communicates with an application server 42. The application server includes the electronic components such as that shown in FIG. 5 including microprocessor 92. In addition, the application server 42 is configured to sit in front of servers which are for different ride provides such as a first ride provider server 43, a second ride provider server 44, a third ride provider server 45, these ride provider servers can be for formalized ride providers such as for UBER® or LYFT®, or any other formalized ride provider, or a separate server for servicing a series of independent drivers 46. In this embodiment, the system acts as a Software As A Service SAAS sitting in front of different platforms.

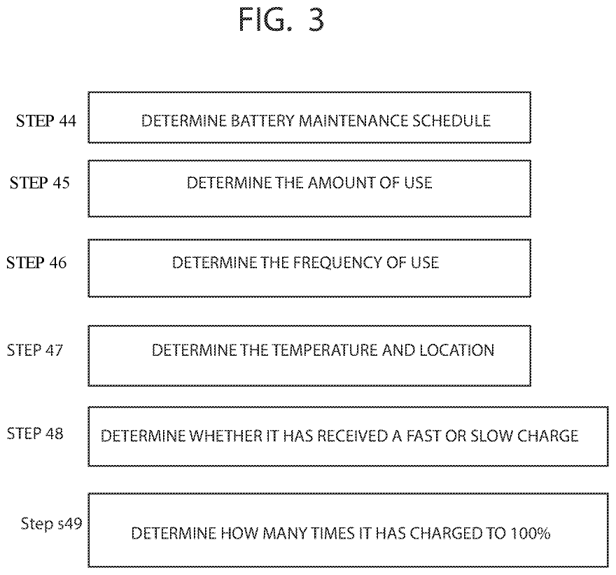

Alternatively, the system can be embedded on an application server 50 wherein the application shown in any one of the steps in FIGS. 1A-1B, 2, and 3 sits on a computer or server 50 embedded as an installed application 50. There would also be a database server 52 which would have information on each of the riders, the drivers and the autos. This network configuration of application server 50 and database is representative of a back end computer network for any of the ride service companies such as UBER® or LYFT®. In addition, in communication with this network is the internet 53 as well as a first handheld device 54, and a computer 55 which can be used to fill out forms and for requesting rides or for registering users, or riders, or drivers or autos as disclosed above in FIGS. 1A, 1B as well as in FIGS. 2 and 3.

FIG. 2 is a flow chart of the variables to consider in charging a vehicle. For example, this is an expansion of step S9, wherein the user can determine the accessories that are used by the user in operation of the vehicle, such as in step S21. Next, in step S22 the system can determine the amount of accessory power needed when operating the car. The accessories can include charging a cell phone, providing power to audio visual devices, heat, air conditioning, radio or other entertainment. Plugging in laptops or other electronic accessories etc. Next, in step S23, the system can determine the design of the motor vehicle such as the type, model, make, tires, and aerodynamics of the vehicle. Next in step S24, the system determines the time of year and season for use of the auto in the route. Next, in step S25 the system determines the road conditions for use of the auto in the route. For example, the system determines based upon road conditions, weather reports and temperature, the condition of the roads. In this way the system can determine if the roads are snowy, icy, wet, slick or hot. Next, in step S26 the system can determine if there is traffic on the roads. Next, in step S27, the system can determine the temperature, climate, weather, windspeed, and wind direction. Next, in step S28 the system can determine based upon traffic conditions, traffic flow, and speed regulations the average driving speed for the vehicle on the route. Next, in step S29 the system can determine whether there are any roadblocks on the road. Next, in step S30 the system can determine the number of passengers and their weight. Next, in step S31 the system can determine the charge rate for the batteries for the auto. Next, in step S32 the system can determine the drain rate for the batteries. Next, in step S33, the system can determine whether there is a boost of speed or power on the roads. Next, in step S34, the system can determine the total elevation that is gained or lost on the route through driving the route. For example, if the beginning of the route is at a base of a mountain and an end of a route is at a top of a mountain then the system would calculate a total elevation gain of for example 500 ft. Or 1000 Ft. This could result in a greater expenditure of power necessary for a route. Once the system determines the variables as shown in FIG. 1 the system proceeds onto step S10 to determine the total power needed.

FIG. 3 shows the process for determining the type of battery used and its chargeability. For example, the system in step S41 can determine a battery maintenance schedule for charging the battery. Next, in step S42 the system can determine the amount of use of the battery. Next, in step S43, the system can determine the frequency of use of the battery. Next, in step S44 the system can determine the temperature and location of the battery during use and charging. Next, in step S45 the system can determine whether the battery has received a fast or a slow charge. Next, in step S46, the system can determine how many times the battery was charged to 100%.

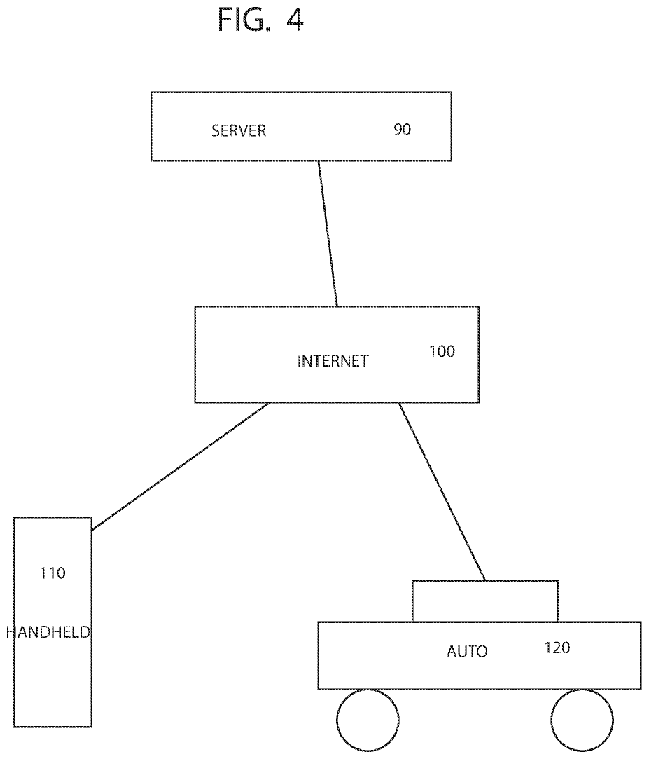

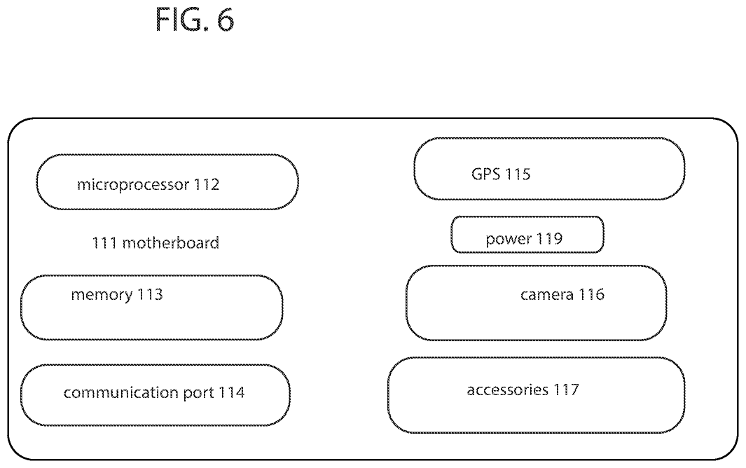

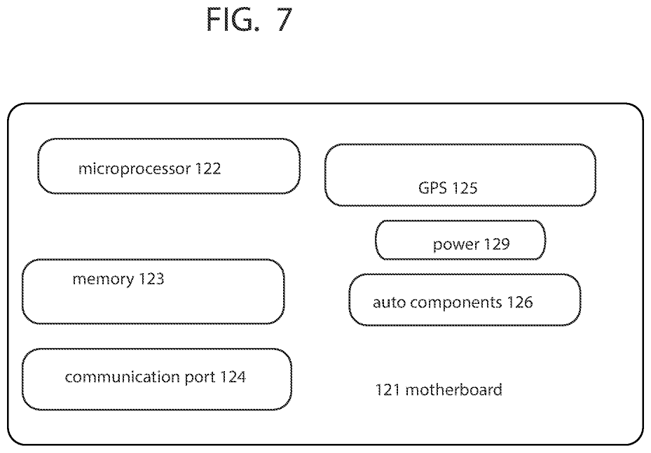

FIG. 4 shows a schematic block diagram of the system for communication of the steps shown above. For example, there is shown a server 90 which includes a microprocessor 92 (see FIG. 5), which is on a motherboard 91. The server can also include a memory 93, as well as a communication port which can communicate via ethernet, WIFI or any other suitable means. Server 90 is in communication with the internet 100 which then communicates with either a computing device 110 which can be either a handheld device such as a phone or any other suitable device. This device can also include a motherboard 111, (see FIG. 6) a microprocessor 112, a memory 113, and a communication port 114 such as WIFI, ethernet, Cellular or any other suitable communication port. This device can also include an optional GPS communication module as 115, well as a camera 116, or other suitable attachments. The auto 120 can be in communication with the system, wherein this auto can have the following components, a motherboard 121 (See FIG. 7), a microprocessor 122, a memory 123, a communications port 124, which can communicate either via WIFI, cellular, ethernet or any other suitable means. This auto 120 can have the microprocessor 122 in communication with the automobile components 126 of the auto such as the motor, the battery, temperature gauges, accessories or any other suitable diagnostic sensors. Thus, this system is configured to allow for electronic communication between these components so that this system is configured to carry out the steps outlined in FIGS. 1-3.

Accordingly, while at least one embodiment of the present invention have been shown and described, it is to be understood that many changes and modifications may be made thereunto without departing from the spirit and scope of the invention as defined in the appended claims.

1. A process for charging an automobile comprising the following steps:
logging in as a user to a system;
requesting a vehicle;
requesting a start time;
requesting a route;
determining using the system comprising a microprocessor, an estimated amount of power needed;
determining a base amount of power;
determining an additional amount of power;
charging the vehicle;
presenting the vehicle for use.

2. The process as in claim 1, wherein the process further comprises the step of determining a run time for the vehicle.

3. The process as in claim 1, further comprising the step of instructing the plugging in of the vehicle.

4. The process as in claim 1, further comprising starting the engine of the vehicle to charge the vehicle.

5. The process as in claim 1, further comprising the step of determining whether to stop the vehicle for charging.

6. The process as in claim 1, further comprising determining whether there are variables in charging the vehicle or in the amount of power needed for the vehicle.

7. The process as in claim 6, wherein at least one variable comprises determining the number of accessories that require power.

8. The process as in claim 6, further comprising the step of determining the amount of accessory power that is needed.

9. The process as in claim 6, further comprising the step of determining the design of the motor vehicle.

10. The process as in claim 6, further comprising the step of determining the time of year and season for use of the vehicle.

11. The process as in claim 1, further comprising the step of determining whether there is traffic for the motor vehicle.

12. The process as in claim 6, further comprising the step of determining the average driving speed.

13. The process as in claim 6, further comprising the step of determining the number of passengers in the vehicle.

14. The process as in claim 6, further comprising the step of determining the average driving speed for the route.

15. The process as in claim 1, further comprising the step of determining a battery maintenance schedule.

16. The process as in claim 1, further comprising the step of determining the amount of use of the vehicle.

17. The process as in claim 1, further comprising the step of determining the frequency of use of the vehicle.

18. The process as in claim 1, further comprising the step of whether the motor vehicle's battery has received a fast or slow charge.

19. The process as in claim 1, further comprising the step of determining how many times that the vehicle has charged to 100%.
